(19) United States
(12) Patent Application Publication
(10) Pub. No.: US 2026/0358620 A1
(43) Pub. Date: Nov. 12, 2026

(54) VARIABLE WAVELENGTH INTERFERENCE FILTER

(71) Applicant: SEIKO EPSON CORPORATION, TOKYO (JP)

(72) Inventor: Kikuya MORITA, SHIOJIRI-SHI (JP)

(21) Appl. No.: 19/670,829

(22) Filed: May 7, 2026

(30) Foreign Application Priority Data
May 8, 2025 (JP) 2025-078183

(51) Int. Cl. G02B 26/00

(52) U.S. Cl. CPC G02B 26/001

(57) ABSTRACT

A variable wavelength interference filter includes a first substrate; a second substrate facing the first substrate in a first direction and including a movable section, a support bonded to the first substrate, and a displacement section connecting the support and the movable section and supporting the movable section to be movable along the first direction; a first reflective film provided on the first substrate; a first capacitance detection electrode provided the first substrate; a second capacitance detection electrode provided on the second substrate and facing the first capacitance detection electrode in the first direction; and an electrostatic actuator that changes a reflection region distance in the multiple reflection region between the first reflective film and the movable section, wherein the second capacitance detection electrode is provided at least in the displacement section.

The present application is based on, and claims priority from JP Application Serial Number, 2025-078183 filed May 8, 2025, the disclosure of which is hereby incorporated by reference herein in its entirety.

### BACKGROUND

### 1. Technical Field

The present disclosure relates to a variable wavelength interference filter.

### 2. Related Art

In the related art, a variable wavelength interference filter that outputs light having a predetermined wavelength according to a gap between reflective films from input light is known. In such a variable wavelength interference filter, there is a case where an electrode for electrostatic capacitance detection is provided in order to measure a gap between the reflective films (for example, refer to JP-A 2014-21264).

The variable wavelength interference filter of JP-A-2014-21264 includes a movable substrate having a movable section supported by a diaphragm, and a fixed substrate facing the movable substrate. The movable section is provided with a movable reflective film, a second drive electrode, and a second capacitance detection electrode, and the fixed substrate is provided with a fixed reflection film facing the movable reflective film, a first drive electrode facing the second drive electrode, and a first capacitance detection electrode facing the second capacitance detection electrode. The inter-reflecting film gap between the fixed reflection film and the movable reflective film, the inter-drive electrode gap between the first drive electrode and the second drive electrode, and the inter-capacitance detection electrode gap between the first capacitance detection electrode and the second capacitance detection electrode are set to have different gap amounts.

In JP-A-2014-21264, a detection circuit for detecting the capacitance between a first capacitance detection electrode and a second capacitance detection electrode is required to measure a change in capacitance within a limited dynamic range. However, within the limited area of the movable section, it is necessary to dispose the movable reflective film, the second drive electrode, and the second capacitance detection electrode. In this case, there is a problem in that the design flexibility of the second capacitance detection electrode is low, and as a result, the amount of gap that can be detected using the capacitance detection electrode is narrowed, and the wavelength selection region of light output from the variable wavelength interference filter is also narrowed.

### SUMMARY

Variable wavelength interference filter according to a first aspect of a present disclosure includes a first substrate;
a second substrate that is a substrate disposed to face the first substrate in a first direction and that includes a movable section facing the first substrate via a gap, a support bonded to the first substrate, and a displacement section that connects the support and the movable section and that supports the movable section to be movable along the first direction; a first reflective film provided on the first substrate and forming a multiple reflection region that performs multiple reflection of incident light between the e first reflective film and the movable section; a first capacitance detection electrode provided on the first substrate; a second capacitance detection electrode provided on the second substrate and facing the first capacitance detection electrode in the first direction; and an electrostatic actuator that changes a reflection region distance that is a distance in the first direction in the multiple reflection region, wherein the second capacitance detection electrode is provided at least in the displacement section.

### BRIEF DESCRIPTION OF THE DRAWINGS

FIG. 1 is a schematic plan view of a variable wavelength interference filter according to a first embodiment and a diagram illustrating a schematic configuration of an optical module including the variable wavelength interference filter.

FIG. 2 is a schematic cross-sectional view of the variable wavelength interference filter taken along line A-A in FIG. 1.

FIG. 3 is a schematic plan view of a second substrate of the variable wavelength interference filter according to the first embodiment when viewed from a first substrate side.

FIG. 4 is a block diagram illustrating a schematic configuration of a filter control section of the first embodiment.

FIG. 5 is a schematic plan view of a second substrate of the variable wavelength interference filter according to a second embodiment.

FIG. 6 is a diagram illustrating another example of the second substrate of the variable wavelength interference filter according to the second embodiment.

FIG. 7 is a diagram illustrating another example of the second substrate of the variable wavelength interference filter according to the second embodiment.

FIG. 8 is a diagram illustrating another example of the second substrate of the variable wavelength interference filter according to the second embodiment.

FIG. 9 is a cross-sectional view illustrating a schematic configuration of the variable wavelength interference filter according to a third embodiment.

FIG. 10 is a diagram illustrating a second substrate of a variable wavelength interference filter according to a first modification.

FIG. 11 is a diagram illustrating another example of the second substrate of the variable wavelength interference filter according to the first modification.

FIG. 12 is a diagram illustrating another example of the second substrate of the variable wavelength interference filter according to the first modification.

FIG. 13 is a diagram illustrating an electrode configuration of the variable wavelength interference filter according to a second modification.

### DESCRIPTION OF EMBODIMENTS

### First Embodiment

Hereinafter, an optical module including a variable wavelength interference filter according to a first embodiment of the present disclosure will be described.

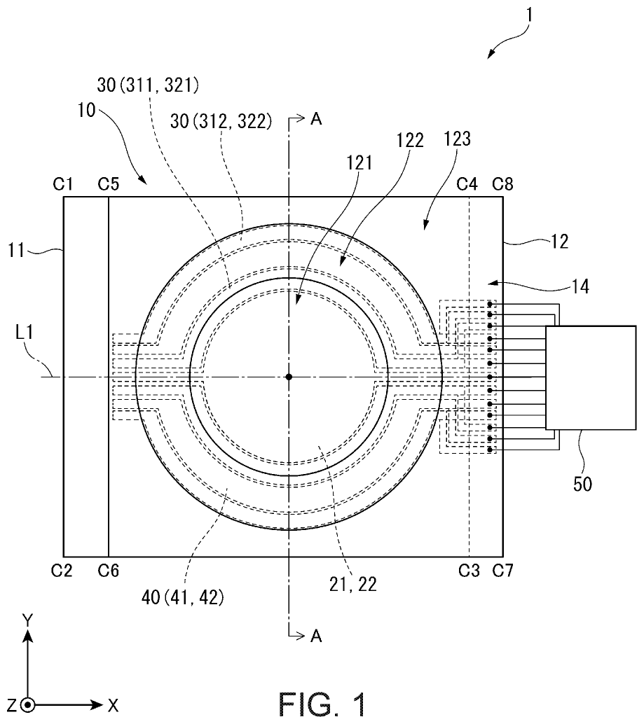

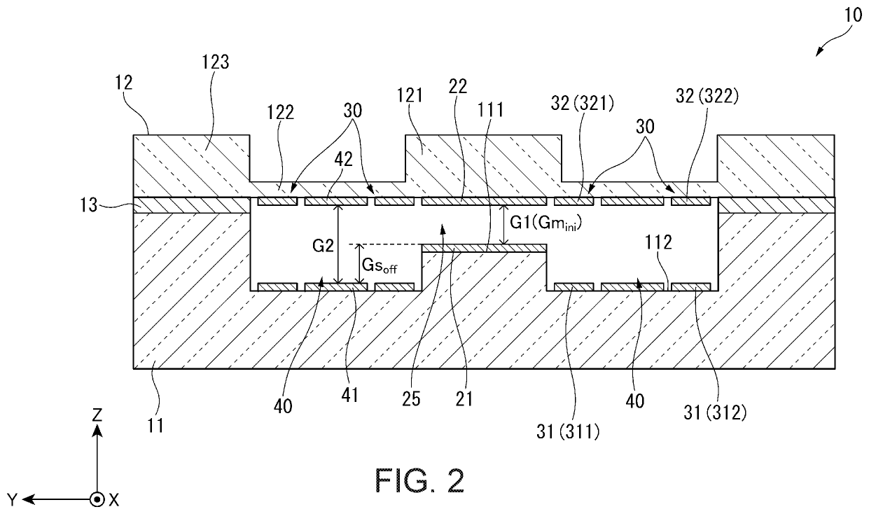

FIG. 1 is a schematic plan view of a variable wavelength interference filter 10 according to a first embodiment and a diagram illustrating a schematic configuration of an optical module 1 including the variable wavelength interference filter 10. FIG. 2 is a schematic cross-sectional view of the variable wavelength interference filter 10 taken along line A-A in FIG. 1.

As illustrated in FIG. 1, the optical module 1 according to the present embodiment includes the variable wavelength interference filter 10 and a filter control section 50 that controls the variable wavelength interference filter 10. The variable wavelength interference filter 10 is a filter that selects and outputs light having a predetermined wavelength from incident light. The filter control section 50 is a circuit that controls the variable wavelength interference filter 10.

### Schematic Configuration of Variable Wavelength Interference Filter 10

As illustrated in FIGS. 1 and 2, the variable wavelength interference filter 10 includes a first substrate 11 and a second substrate 12. The first substrate 11 and the second substrate 12 are bonded to each other by a bonding film 13 such as a plasma polymerized film containing siloxane as a main component, for example, and are integrally formed. In the following description, a direction from the first substrate 11 toward the second substrate 12 (a first direction of the present disclosure) is defined as a Z-direction, one direction orthogonal to the Z-direction is defined as an X-direction, and a direction orthogonal to the Z-direction and the X-direction is defined as a Y-direction.

In the variable wavelength interference filter 10 of the present embodiment, a first reflective film 21 is provided on the first substrate 11 and a second reflective film 22 is provided on the second substrate 12. The first reflective film 21 and the second reflective film 22 are disposed to face each other with an inter-reflecting film gap G1 (reflection region distance) between the reflective films. It should be noted that a region between the first reflective film 21 and the second reflective film 22 constitutes a multiple reflection region 25 of the present disclosure in which light incident on the variable wavelength interference filter 10 is multiply reflected. The variable wavelength interference filter 10 causes the incident light incident from the Z-direction to be multiply reflected between the first reflective film 21 and the second reflective film 22, and causes light of a predetermined wavelength intensified by interference to be emitted from the variable wavelength interference filter 10.

The variable wavelength interference filter 10 includes electrostatic actuators 30 as electrostatic actuators according to the embodiment of the disclosure that change the dimensions of the inter-reflecting film gap G1, and capacitance detection section 40 sections 40 for measuring the distances of the inter-reflecting film gap G1. The variable wavelength interference filter 10 according to the present embodiment can change the wavelengths of light emitted from the variable wavelength interference filter 10 by changing the distance of the inter-reflecting film gap G1 with the electrostatic actuators 30. In the variable wavelength interference filter 10 according to the present embodiment, based on the distance of the inter-reflecting film gap G1 detected using the capacitance detection section 40, the distance of the inter-reflecting film gap G1 can be feedback controlled. By this, the variable wavelength interference filter 10 can accurately emit light that has a desired wavelength.

Hereinafter, the configuration of each section will be described in more detail.

### Configuration of First Substrate 11

The first substrate 11 is formed, for example, to have a larger thickness dimension than the second substrate 12, and the first substrate 11 is suppressed when an electrostatic attraction is caused to act by the electrostatic actuators 30. As illustrated in FIG. 2, the first substrate 11 includes a reflection film installation section 111 and an electrode arrangement section 112 on a surface facing the second substrate 12.

In the present embodiment, one end side (for example, the edge C1 to C2 in FIG. 1) of the first substrate 11 protrudes more than one end side (the edge C5 to C6) of the second substrate 12, and can be used as a fixing section when the variable wavelength interference filter 10 is fixed to, for example, a package housing, a base, or the like.

The reflection film installation section 111 and the electrode arrangement section 112 are bottom surfaces of grooves formed by processing the surface of the first substrate 11 facing the second substrate 12 into a recessed shape by a method such as multi-stage etching, and are flat surfaces parallel to the XY plane. In the present embodiment, the distance between the reflection film installation section 111 and the second substrate 12 is shorter than the distance between the electrode arrangement section 112 and the second substrate 12. That is, the groove depth of the reflection film installation section 111 in the first substrate 11 is shallower than the groove depth of the electrode arrangement section 112.

It should be noted that the distances of the reflection film installation section 111 and the electrode arrangement section 112 with respect to the second substrate 12 are not limited to the above, and for example, the distance between the reflection film installation section 111 and the second substrate 12 may be greater than the distance between the electrode arrangement section 112 and the second substrate 12.

That is, the distance between the reflection film installation section 111 and the second substrate 12 and the distance between the electrode arrangement section 112 and the second substrate 12 are set according to the wavelength region (driving wavelength region) of light to be output from the variable wavelength interference filter 10.

In the present embodiment, a movable section 121 (to be described later) of the second substrate 12 is swept toward the first substrate 11 by the electrostatic actuators 30, and in this case, the distance between the reflection film installation section 111 and the second substrate 12 is set based on the maximum wavelength of the driving wavelength region. The distance between the electrode arrangement section 112 and the second substrate 12 is set according to the width of the driving wavelength region. For example, in the case of setting a wide driving wavelength region, it is necessary to increase the maximum displacement amount of the movable section 121. Therefore, the distance between the electrode arrangement section 112 and the second substrate 12 is set so that the maximum displacement amount of the movable section 121 can be secured by the electrostatic attraction of the electrostatic actuators 30. As the distance between the electrode arrangement section 112 and the second substrate 12 is smaller, a larger electrostatic attraction can be applied, but the gap control becomes difficult due to high responsiveness. On the other hand, as the distance between the electrode arrangement section 112 and the second substrate 12 increases, the responsiveness decreases, and thus the gap control becomes difficult, but the electrostatic attraction becomes weak. Therefore, the distance between the reflection film installation section 111 and the second substrate 12 and the distance between the electrode arrangement section 112 and the second substrate 12 are set based on the driving wavelength region of the light to be output from the variable wavelength interference filter 10, the electrode area of the electrostatic actuators 30, and the drive voltage that can be applied to the electrostatic actuators 30. Therefore, in some cases, the distance between the reflection film installation section 111 and the second substrate 12 may be greater than the distance between the electrode arrangement section 112 and the second substrate 12, or the distance between the reflection film installation section 111 and the second substrate 12 may be the same as the distance between the electrode arrangement section 112 and the second substrate 12.

In the present embodiment, the first drive electrodes 31 (refer to FIG. 2), which configure the electrostatic actuators 30, and the first capacitance detection electrodes 41, which configure the capacitance detection sections 40, are disposed in the electrode arrangement section 112. In an example illustrated in FIG. 2, an example is illustrated in which the first drive electrodes 31 and the first capacitance detection electrodes 41 are disposed on the same plane, but the distance between the first drive electrodes 31 and the second substrate 12 and the distance between the first capacitance detection electrodes 41 and the second substrate 12 may be different from each other. That is, in the electrode arrangement section 112, the groove depth of the portion where the first drive electrodes 31 are arranged and the groove depth of the portion where the first capacitance detection electrodes 41 are arranged may be different from each other.

Further, the first drive electrodes 31 may be configured by a plurality of electrodes. For example, in the present embodiment, the first drive electrodes 31 include bias first drive electrodes 311 and control first drive electrodes 312. Although an example in which the bias first drive electrodes 311 and the control first drive electrodes 312 are disposed on the same plane is shown, the distance between the bias first drive electrodes 311 and the second substrate 12 and the distance between the control first drive electrodes 312 and the second substrate 12 may be different from each other. That is, in the electrode arrangement section 112, the groove depth of the portion where the bias first drive electrodes 311 are arranged and the groove depth of the portion where the control first drive electrodes 312 are arranged may be different from each other.

As described above, in the present embodiment, the first reflective film 21 is provided on the reflection film installation section 111. The first reflective film 21 has the same shape as the reflection film installation section 111 and, for example, in the present embodiment, is formed in a circular shape as illustrated in FIG. 1. The first reflective film 21 is not particularly limited as long as it is a reflective film that transmits a part of incident light and reflects a part of the incident light, and for example, a metal film such as a silver alloy, a dielectric multilayer film in which a dielectric film having a high refractive index and a dielectric film having a low refractive index are alternately laminated, or the like can be used.

The first drive electrodes 31 (the bias first drive electrodes 311 and the control first drive electrodes 312), which configure the electrostatic actuators 30, and the first capacitance detection electrodes 41, which configure the capacitance detection section 40, are disposed in the electrode arrangement section 112.

In the present embodiment, in the electrode arrangement section 112, the bias first drive electrodes 311 are arranged on the inner side close to the reflection film installation section 111, the first capacitance detection electrodes 41 are arranged on the outer side thereof, and the control first drive electrodes 312 are arranged on the further outer side thereof.

In the present embodiment, the first drive electrodes 31 are disposed at positions where the pair of first drive electrodes 31 are disposed at positions symmetric with respect to a reference line L1 passing through the center point of the first reflective film 21. For example, as illustrated in FIG. 1, one of the bias first drive electrodes 311, which has a semicircular arc shape, and one of the control first drive electrodes 312, which has a semicircular arc shape, are disposed on the +Y side of the reference line L1. In order for the bias first drive electrodes 311 and the control first drive electrodes 312 to be symmetric with respect to the reference line L1, the semicircular arc shape of the other bias first drive electrodes 311 and the semicircular arc shape of the other control first drive electrodes 312 are disposed on the −Y side of the reference line L1.

Similarly, in the first capacitance detection electrodes 41, one of the first capacitance detection electrodes 41, which has a semicircular arc shape, is disposed on the +Y side of the reference line L1 and, so as to be line-symmetric with respect to the reference line L1 relative to that one of the first capacitance detection electrodes 41, the other of the first capacitance detection electrodes 41, which has a semicircular arc shape, is disposed on the −Y side of the reference line L1.

The first drive electrodes 31 and the first capacitance detection electrodes 41 are respectively drawn out to a wiring section 14 provided in a part of the variable wavelength interference filter 10, and are electrically connected to the filter control section 50 in the wiring section 14. The position where the wiring section 14 is provided is not particularly limited and, for example, in the example of FIG. 1, the wiring section 14 is disposed along the edge C7 to C8 (an end edge on the +X side) of the second substrate 12.

The first reflective film 21 may be drawn out to the wiring section 14 by a lead-out line and, in this case, a ground (GND) potential can be set to the first reflective film 21. The first drive electrodes 31 and the first capacitance detection electrodes 41 may be connected to the filter control section 50 via a wiring circuit configured by a lead wire or a flexible printed circuit board, or a terminal of the filter control section 50 may be directly bonded to the wiring section 14.

### Configuration of Second Substrate 12

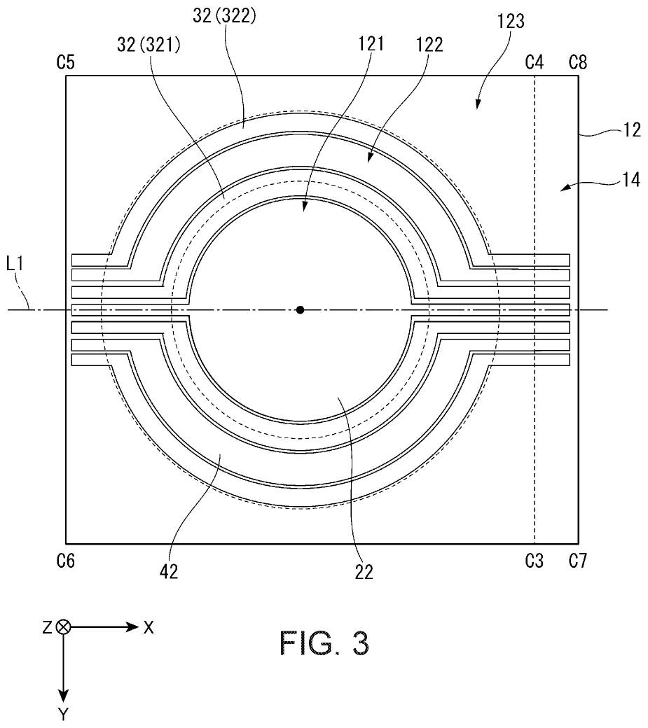

FIG. 3 is a schematic plan view of the second substrate 12 as viewed from the first substrate 11 side.

The second substrate 12 has an annular shaped recessed groove formed on a surface opposite from the first substrate 11 by using, for example, etching or the like. By this, the second substrate 12 is configured to include the movable section 121 inside the recessed groove, the displacement section 122 formed by the recessed groove and surrounding the movable section 121, and the support 123 on an outer side of the recessed groove (displacement section 122).

In the present embodiment, the end section of the edge C7 to C8 of the second substrate 12 protrudes to the +X side from the edge C3 to C4 (+X side) of the first substrate 11, and configures the above-described wiring section 14.

The movable section 121 is formed to have a thickness dimension larger than that of the displacement section 122 and, for example, in the present embodiment, is formed to have the same dimension as the thickness dimension of the support 123. The movable section 121, in a plan view of the variable wavelength interference filter 10 viewed from the Z-direction, faces the reflection film installation section 111 of the first substrate 11. The movable section 121, in a plan view viewed from the Z-direction, is formed to have a diameter dimension larger than at least the diameter dimension of the outer peripheral edge of the first reflective film 21.

The displacement section 122 is a diaphragm surrounding the movable section 121, and is formed to have a thickness dimension smaller than that of the movable section 121. The displacement section 122 supports the movable section 121 so as to be movable in the Z-direction. Since the displacement section 122 has a thickness in the Z-direction larger than that of the movable section 121, the displacement section 122 more easily bends than the movable section 121, and the movable section 121 can be displaced toward the first substrate 11 by a slight electrostatic attraction. Since the movable section 121 has the larger thickness dimension and a higher stiffness than the displacement section 122, even when the movable section 121 is pulled toward the first substrate 11 by the electrostatic attraction, the shape change of the movable section 121 can be suppressed.

It should be noted that in the present embodiment, the displacement section 122 having a diaphragm shape is illustrated, but this is not a limitation. Other examples of the displacement section 122 will be described in a second embodiment and subsequent embodiments (to be described later).

The support 123 is a portion that holds the outer peripheral side of the displacement section 122. The support 123 is bonded to the first substrate 11 via the bonding film 13 further to the outer periphery than the groove constituting the electrode arrangement section 112.

In the present embodiment, the second reflective film 22 is provided on a surface of the movable section 121 of the second substrate 12 facing the first reflective film 21.

The second reflective film 22 is preferably made of the same material as the first reflective film 21.

Second drive electrodes 32 (refer to FIGS. 2 and 3) are provided in a position facing the first drive electrodes 31 of the second substrate 12, and second capacitance detection electrodes 42 provided in a position facing the first capacitance detection electrodes 41 of the second substrate 12. The second drive electrodes 32: include bias second drive electrodes 321 that face the bias first drive electrodes 311 and control second drive electrodes 322 that face the control first drive electrodes 312.

The second capacitance detection electrodes 42 are disposed on the displacement section 122 between the bias second drive electrodes 321 and the control second drive electrodes 322.

More specifically, in the present embodiment, the bias second drive electrodes 321 provided in a position closest to the second reflective film 22 are disposed straddling from the movable section 121 to the displacement section 122. The second capacitance detection electrodes 42 are disposed on the displacement section 122 at a predetermined interval on an outer side of the bias second drive electrodes 321. The control second drive electrodes 322 are disposed on the displacement section 122 with a predetermined gap on an outer side of the second capacitance detection electrodes 42.

The electrode shapes of the bias second drive electrodes 321, the second capacitance detection electrodes 42, and the control second drive electrodes 322 are the same as the electrode shapes of the bias first drive electrodes 311, the first capacitance detection electrodes 41, and the control first drive electrodes 312, and the electrodes are disposed on the +Y sides so as to be line-symmetric with respect to the reference line L1. In the following description, a set of the bias first drive electrodes 311 and the bias second drive electrodes 321, which face the bias first drive electrodes 311, may be referred to as a bias drive electrodes 311, 321. A set of the control first drive electrodes 312 and the control second drive electrodes 322 facing the control first drive electrodes 312 may be referred to as control drive electrodes 312, 322.

It should be noted that the electrode patterns of the second drive electrodes 32 and the second capacitance detection electrodes 42 illustrated in FIG. 3 in the present embodiment are examples, and are not limitations. In particular, the relative position and the relative size of the second capacitance detection electrodes 42, according to the driving wavelength region of the variable wavelength interference filter 10, can be appropriately set with respect to the displacement section 122. For example, in a case where the driving wavelength region is wide, the second capacitance detection electrodes 42 may be disposed closer to the support 123 side, or the electrode area may be made smaller. In a case where the driving wavelength region is narrow, the second capacitance detection electrodes 42 may be disposed closer to the movable section 121 side, or the electrode area may be increased.

In the variable wavelength interference filter 10 of the present embodiment, the displacement section 122 bends under the electrostatic attraction generated by the electrostatic actuators 30, and the movable section 121 is displaced toward the first substrate 11. However, the displacement amount of the movable section 121 for switching the wavelength of the light output from the variable wavelength interference filter 10 is sufficiently small to the extent that it can be ignored compared to the electrode area (the area in a plan view viewed from the Z-direction) of each of the electrodes 31, 41, 32, and 42. Therefore, in a plan view as viewed from the Z-direction, the area of where the bias first drive electrodes 311 and the bias second drive electrodes 321 overlap each other, the area of where the first capacitance detection electrodes 41 and the second capacitance detection electrodes 42 overlap each other, and the areas of where the control first drive electrodes 312 and the control second drive electrodes 322 overlap each other can be regarded as substantially constant even when the movable section 121 is displaced and the displacement section 122 bends.

Similarly to the first drive electrodes 31 and the first capacitance detection electrodes 41, the second drive electrodes 32 and the second capacitance detection electrodes 42 are respectively drawn out to the wiring section 14, and are electrically connected to the filter control section 50 in the wiring section 14.

Similarly to the first reflective film 21, the second reflective film 22 may also be drawn out to the wiring section 14 by a lead-out line, and in this case, the ground (GND) potential is configured to be set in the second reflective film 22.

### Characteristics of Capacitance Detection Section 40

The electrostatic capacitance C held between the first capacitance detection electrodes 41 and the second capacitance detection electrodes 42 constituting the capacitance detection section 40 satisfies the condition shown in the following equation (1).

$$Equation 1$$

$$C = \frac{ε S}{D} = \frac{ε S}{( {Gm}_{ini} - {Gs}_{off} ) - x \cdot α} \qquad ( 1 )$$

In equation (1), ε is a dielectric constant between the first capacitance detection electrodes 41 and the second capacitance detection electrodes 42. In plan view of the variable wavelength interference filter 10 viewed from the Z-direction, S is the electrode area of where the first capacitance detection electrodes 41 and the second capacitance detection electrodes 42 overlap each other. D is an average value of the distance between the first capacitance detection electrodes 41 and the second capacitance detection electrodes 42 in the Z-direction. Gmᵢₙᵢ is the inter-reflecting film gap G1 (initial reflective film gap) in a state in which the electrostatic actuators 30 are not driven and the movable section 121 is not displaced. Gs_{off} is an offset amount of an inter-capacitance detection electrode gap G2 between the first capacitance detection electrodes 41 and the second capacitance detection electrodes 42 along the Z-direction with respect to an initial reflective film gap Gmᵢₙᵢ, Which is the state of the movable section 121 when not displaced. The inter-capacitance detection electrode gap G2 is an average value of the distances between the first capacitance detection electrodes 41 and the second capacitance detection electrodes 2 along the Z-direction. The symbol x represents the displacement amount of the movable section 121 in the Z-direction. The symbol a is a predetermined coefficient that satisfies 0<a<1.

The displacement amount x is controlled by an applied voltage (bias voltage) applied to the bias first drive electrodes 311 and the bias second drive electrodes 321 of the electrostatic actuators 30 and an applied voltage (control voltage) applied to the control first drive electrodes 312 and the control second drive electrodes 322.

In the present embodiment, the coefficient a is calculated in advance by measuring in advance the change in the electrostatic capacitance C with respect to the change in the displacement amount x of the movable section 121. Although details will be described later, the calculated coefficient a is used when the filter control section 50 calculates the displacement amount x of the movable section 121.

### Configuration of Filter Control Section 50

Next, the filter control section 50 will be described.

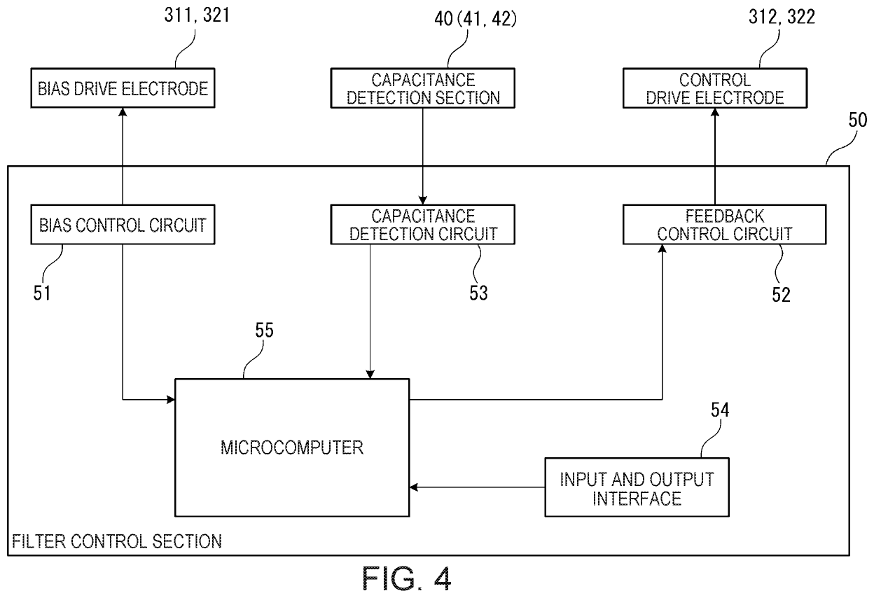

FIG. 4 is a block diagram illustrating a schematic configuration of the filter control section 50.

The filter control section 50 includes, for example, a bias control circuit 51, a feedback control circuit 52, a capacitance detection circuit 53, an input and output interface 54, a microcomputer 55, and the like.

The bias control circuit 51 is a circuit that controls a bias voltage applied between the bias first drive electrodes 311 and the bias second drive electrodes 321 of the electrostatic actuators 30. The bias control circuit 51 applies a bias voltage based on a bias command value input from the microcomputer 55 between the bias first drive electrodes 311 and the bias second drive electrodes 321.

The feedback control circuit 52 is a circuit that controls a control voltage applied between the control first drive electrodes 312 and the control second drive electrodes 322 of the electrostatic actuators 30.

For example, in the present embodiment, the microcomputer 55 calculates the distance of the inter-reflecting film gap G1 based on the electrostatic capacitance detected by the capacitance detection circuit 53 (to be described later), and outputs a command value of the control voltage to the feedback control circuit 52 so that the distance of the inter-reflecting film gap G1 becomes a target distance corresponding to the target wavelength. By this, the feedback control circuit 52 performs feedback control of the control voltage applied to the control first drive electrodes 312 and the control second drive electrodes 322 of the electrostatic actuators 30 so that the wavelength of the light output from the variable wavelength interference filter 10 becomes the target wavelength.

Here, in the present embodiment, the pair of bias drive electrodes 311, 321 are provided so as to be symmetric with respect to the reference line L1. In the present embodiment, the pair of bias drive electrodes 311, 321 are connected to one bias control circuit 51. The same applies to the feedback control circuit 52 and, in the present embodiment, the pair of control drive electrodes 312, 322, which are symmetric with respect to the reference line L1, are connected to one feedback control circuit 52.

On the other hand, the bias control circuit 51 may be provided for each of the pair of bias drive electrodes 311, 321. In this case, each set of bias drive electrodes 311, 321 can be individually driven. Similarly, the feedback control circuit 52 may be provided for each of the pairs of control drive electrodes 312, 322, which are symmetric with respect to the reference line L1. In such a configuration, the driving of the electrostatic actuators 30 can be controlled so as to suppress the inclination of the movable section 121 in a direction (the Y-direction in the examples of FIGS. 1 and 3) orthogonal to the reference line L1.

The capacitance detection circuit 53 measures the electrostatic capacitance between the first capacitance detection electrodes 41 and the second capacitance detection electrodes 42 of the capacitance detection section 40. The capacitance detection circuit 53 outputs the measurement result of the electrostatic capacitance to the microcomputer 55.

Normally, the capacitance detection circuit 53 has a limited dynamic range of detectable electrostatic capacitance. Therefore, it is necessary to appropriately set a distance D of the inter-capacitance detection electrode gap G2 of the first capacitance detection electrodes 41 and the second capacitance detection electrodes 42, an electrode area S, and an dielectric constant ε so that the electrostatic capacitances to be subjected to capacitance detection are included in the dynamic range.

Here, in the variable wavelength interference filter in the related art, the electrode for electrostatic capacitance detection is provided in the movable section 121. However, the second reflective film 22 needs to be provided on the movable section 121, and in some cases, the second drive electrodes 32 may also be provided on the movable section 121. In this case, when the electrode area of the electrode for electrostatic capacitance detection is increased, the size of the second reflective film 22 is reduced, and the effective diameter of the variable wavelength interference filter 10 is reduced, so that, when the variable wavelength interference filter 10 is applied as a spectral camera, the field of view and the resolution are reduced. When the electrode area of the second drive electrodes 32 is reduced, the electrostatic attraction for displacing the movable section 121 is reduced and the driving wavelength region becomes narrower. That is, in the variable wavelength interference filter of the related art, the flexibility of the electrode area S of the capacitance detection section 40 is low and it is necessary to form the variable wavelength interference filter so that the electrostatic capacitance falls within the dynamic range only by the distance D of the inter-capacitance detection electrode gap G2.

In contrast, in the variable wavelength interference filter 10 of the present embodiment, as described above, the second capacitance detection electrodes 42 constituting the capacitance detection section 40 are disposed in the displacement section 122. In the configuration in which the second capacitance detection electrodes 42 provided in the displacement section 122, the area of the second capacitance detection electrodes 42 can be increased compared to a case where the second capacitance detection electrode is provided in the movable section 121 in which the second reflective film 22 needs to be disposed. This can improve the degree of freedom of the electrode area S in the capacitance detection section 40. Therefore, in the present embodiment, the capacitance of the capacitance detection section 40 can be designed to be within the dynamic range of the capacitance detection circuit 53 by both the electrode area S of the capacitance detection section 40 and the distance D of the inter-capacitance detection electrode gap G2. That is, in the present embodiment, compared to the variable wavelength interference filter of the related art, the design flexibility in the capacitance detection section 40 is increased.

As described above, in the present embodiment, the capacitance in the capacitance detection section 40 can be designed to be within the dynamic range of the capacitance detection circuit 53 and, by this, the displacement amount x of the movable section 121 can be calculated with high accuracy by the capacitance detection circuit 53. Therefore, it is possible to perform the feedback control of the control voltage with high accuracy by the feedback control circuit 52, and it is possible to output light of the target wavelength from the variable wavelength interference filter 10.

It should be noted that in the present embodiment, the capacitance detection circuit 53 calculates the average value of the electrostatic capacitances detected by the pair of capacitance detection electrodes 41, 42, which are symmetric with respect to the reference line L1.

On the other hand, as described above, in the configuration in which the bias control circuit 51 is provided for each of the pair of bias drive electrodes 311, 321 that are line-symmetric with respect to the reference line L1 and the feedback control circuit 52 is provided for each of the pair of control drive electrodes 312, 322 that are line-symmetric with respect to the reference line L1, the capacitance detection circuit 53 may be provided for each of the pair of capacitance detection electrodes 41, 42 that are line-symmetric with respect to the reference line L1. In this case, by measuring the electrostatic capacitance of each of the pair of capacitance detection electrodes 41, 42, it is possible to measure the inclination of the movable section 121 along the Y-direction. By this, the bias drive electrodes 311, 321 and the control drive electrodes 312, 322 can be driven in a direction in which the inclination of the movable section 121 is suppressed.

The input and output interface 54 is an interface for outputting and inputting various types of information. For example, an optical module 1 of the present embodiment may be incorporated into a spectral camera, and in this case, a request signal for dispersing light having a predetermined target wavelength is received from a camera control system of the spectral camera and is output to the microcomputer 55. Thus, the microcomputer 55 outputs a bias command value corresponding to the target wavelength requested by the request signal to the bias control circuit 51. The microcomputer 55 outputs a control voltage command value to the feedback control circuit 52 so that the distance of the inter-reflecting film gap G1 corresponding to the electrostatic capacitance detected by the capacitance detection circuit 53 becomes a target distance.

The microcomputer 55 controls the operation of the variable wavelength interference filter 10 based on the request signal input from the input and output interface 54.

Specifically, the microcomputer 55 outputs a bias command value to the bias control circuit 51 based on the target wavelength included in the request signal input via the input and output interface 54. The bias command value for the target wavelength may be stored in advance in a storage device such as a memory.

Further, the microcomputer 55 calculates the displacement amount x of the movable section 121 based on the electrostatic capacitance detected by the capacitance detection circuit 53. Specifically, based on the above-described equation (1), the displacement amount x is calculated. In the equation (1), the initial reflective film gap Gmᵢₙᵢ, the offset amount Gs_{off} of the inter-capacitance detection electrode gap G2, the dielectric constant ε, the electrode area S, and the coefficient a are known values. It should be noted that the coefficient a is a value measured in advance at the time of manufacturing the variable wavelength interference filter 10. Therefore, the microcomputer 55 can calculate the displacement amount x of the movable section 121 from the electrostatic capacitance C measured by the capacitance detection circuit 53 and equation (1), that is, the distance change amount of the inter-reflecting film gap G1.

In the present embodiment, map data indicating a relationship between the wavelength of the light output (dispersed) from the variable wavelength interference filter 10 and the displacement amount x of the movable section 121 is stored in advance in the storage device. By this, the microcomputer 55 can specify the wavelength (output wavelength) of the light actually output from the variable wavelength interference filter 10 with respect to the calculated displacement amount x, and can calculate the control voltage from the difference between the output wavelength and the target wavelength. Alternatively, the inter-reflecting film gap G1 corresponding to the target wavelengths may be calculated as the target distances from the above-described map data, and the control voltages may be calculated so that the inter-reflecting film gap G1 becomes the target distances. The microcomputer 55 outputs a control voltage command including the calculated control voltage to the feedback control circuit 52 and, by this, the feedback control circuit 52 applies the control voltage between the control first drive electrodes 312 and the control second drive electrodes 322 of the variable wavelength interference filter. By this, the variable wavelength interference filter 10 outputs light of a target wavelength.

### Operational Effects of Present Embodiment

The variable wavelength interference filter 10 of the present embodiment includes the first substrate 11 and the second substrate 12. The first substrate 11 is provided with the first reflective film 21, the first drive electrodes 31, and the first capacitance detection electrodes 41. The second substrate 12 is provided with the second reflective film 22 facing the first reflective film 21, the second drive electrodes 32 facing the first drive electrodes 31, and the second capacitance detection electrodes 42 facing the first capacitance detection electrodes 41. In the present embodiment, the second capacitance detection electrodes 42 are provided in the displacement section 122 of the second substrate 12.

In such a configuration, compared to a configuration in which the second capacitance detection electrodes 42 are provided in the movable section 121, the area efficiency of the second capacitance detection electrodes 42 can be improved. That is, without reducing the area of the second reflective film 22 provided on the movable section 121, the electrode area of the second capacitance detection electrodes 42 can be increased. This makes it possible to design the electrostatic capacitance of the capacitance detection section 40 based on the electrode area S and the offset amount Gs_{off} of the inter-capacitance detection electrode gap G2 with respect to the initial reflective film gap Gmᵢₙᵢ, and to improve the design flexibility of the capacitance detection section 40.

In the variable wavelength interference filter 10 according to the present embodiment, each parameter is set so as to satisfy equation (1).

In a case where the second capacitance detection electrodes 42 are provided in the displacement section 122, a distance between the first capacitance detection electrodes 41 and the second capacitance detection electrodes 42 changes depending on a position. In contrast, in the present embodiment, by satisfying the condition of equation (1), even when the distance between the first capacitance detection electrodes 41 and the second capacitance detection electrodes 42 changes depending on the position and the variation occurs, the displacement amount x of the movable section 121 can be calculated with high accuracy based on equation (1).

In the present embodiment, the displacement section 122 is formed of a diaphragm surrounding the outer periphery of the movable section 121.

In this manner, by adopting a configuration in which the displacement section 122 surrounds the entire outer periphery of the movable section 121, it is possible to suppress a decrease in stiffness of the second substrate 12.

The variable wavelength interference filter 10 according to the present embodiment includes, as the electrostatic actuator, the first drive electrodes 31 provided on the first substrate 11 and the second drive electrodes 32 provided on the second substrate 12 and facing the first drive electrodes 31. The second drive electrodes 32 and the second capacitance detection electrodes 42 are provided in the displacement section 122, and in the displacement section 122, the second capacitance detection electrodes 42 are disposed on a side closer to the support 123 than the second drive electrodes 32 (the bias second drive electrodes 321).

In this manner, by disposing the bias second drive electrodes 321 on the side closer to the second reflective film 22, it is possible to suppress bending of the movable section 121 and to output light of the target wavelength from the variable wavelength interference filter 10 with high accuracy.

### Second Embodiment

Next, the second embodiment will be described.

In the first embodiment, the configuration has been exemplified in which the second substrate 12 includes the displacement section 122, which has a diaphragm shape surrounding the movable section 121, and the second capacitance detection electrodes 42, which have an arc shape centered on the movable section 121, are provided in the displacement section 122, which has a diaphragm shape. However, in the present disclosure, the shape of the displacement section 122 is not limited to the above. In the second embodiment, another configuration example of the displacement section 122 will be described. It should be noted that in the following description, the same reference symbol is given to the same component as those already described, and the description thereof will be omitted or simplified.

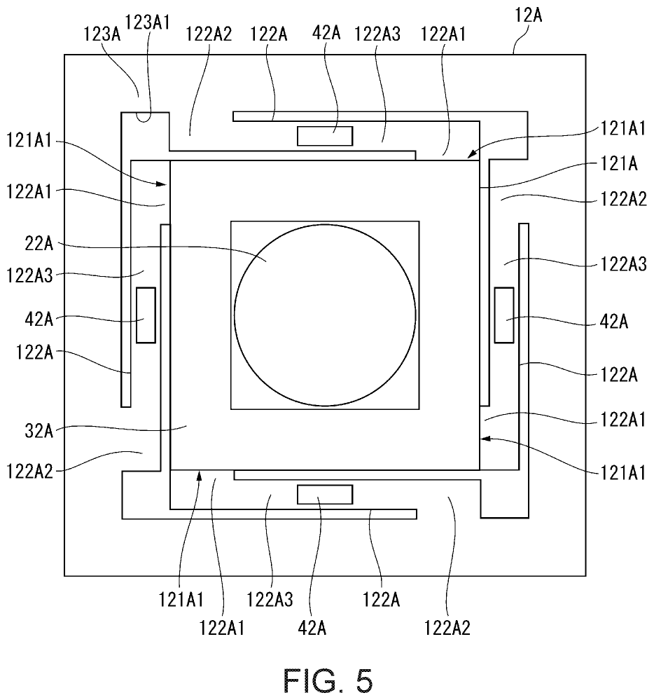

FIG. 5 is a schematic plan view of a second substrate 12A of the variable wavelength interference filter according to the second embodiment.

The variable wavelength interference filter of the present embodiment is obtained by changing the second substrate 12 of the variable wavelength interference filter 10 of the first embodiment to a second substrate 12A illustrated in FIG. 5. The first substrate 11 has the same configuration as that of the first embodiment. However, the first reflective film 21, the first drive electrodes 31, and the first capacitance detection electrodes 41 are provided at positions facing a second reflective film 22A, second drive electrodes 32A, and second capacitance detection electrodes 42A, respectively, which are provided on the second substrate 12A illustrated in FIG. 5.

The second substrate 12A of the present embodiment includes, similarly to the second substrate 12 of the first embodiment, a movable section 121A, a displacement section 122A, and a support 123A. Here, in the present embodiment, as illustrated in FIG. 5, the movable section 121A is formed in a rectangular shape in a plan view seen from the Z-direction.

In the variable wavelength interference filter according to the aspect of the present disclosure, t is preferable that the movable section has a shape that is hardly affected by deformation of the displacement section. For example, as in the first embodiment, in a case where the displacement section 122 has a diaphragm shape surrounding the movable section 121, it is preferable that the displacement section 122 has a circular shape capable of uniformly dispersing stress applied to the movable section 121 from the displacement section 122 at the time of displacement.

On the other hand, in the second embodiment, the displacement section 122A is formed of a beam member. In this case, the positions of the movable section 121A to which the displacement section 122A of the beam members are connected are arranged at equal angular intervals, and the stresses acting on the movable section 121A from the respective displacement section 122A are made uniform. For example, in the example of FIG. 5, four displacement sections 122A are arranged at equal angular intervals at the rectangular corner portions of the movable section 121A. It should be noted that in the example of FIG. 5, the movable section 121A has a rectangular shape, but the movable section 121A may have a circular shape or other regular polygonal shapes. In this case, the displacement sections 122A may be arranged at equal angular intervals.

The displacement sections 122A connect, similarly to the first embodiment, the movable section 121A and the support 123A to each other and supports the movable section 121A so as to be displaceable in the Z-direction.

The displacement sections 122A of the present embodiment includes, for example, a first connection section 122A1 that is connected to each edge of the rectangular shaped movable section 121A and that extends from the movable section 121A toward the support 123A when viewed from the Z-direction, a second connection section 122A2 that extends from the support 123A toward the movable section 121A, and a flexible section 122A3 that connects the first connection section 122A1 to the second connection section 122A2.

To be specific, the first connection section 122A1 extends from one end section (rectangular corner section 121A1) of each edge of the movable section 121A in a direction orthogonal to the edge of the rectangle. The support 123A has a rectangular shaped inner frame section 123A1 facing each edge of the movable section 121A, and the second connection section 122A2 extends toward the movable section 121A in a direction orthogonal to an edge of the inner frame section 123A1. For example, the position of the inner frame section 123A1 to which the second connection section 122A2 is connected is a position facing the other end section of a side of the movable section 121A on the opposite side from one end section to which the first connection section 122A1 of the edge of the movable section 121A is provided. The flexible section 122A3 extends parallel to the edge of the movable section 121A.

It should be noted that the shape of the flexible section 122A3 may be changed as appropriate depending on the driving wavelength region. For example, in the case of widening the driving wavelength region, it is sufficient to widen the range in which the movable section 121A can be displaced. In this case, the width of the flexible section 122A3 may be narrowed, or the flexible section 122A3 may be formed in a meandering shape between the first connection section 122A1 and the second connection section 122A2

Similarly to the first embodiment, the second reflective film 22A, the second drive electrodes 32A, and the second capacitance detection electrodes 42A are provided on the second substrate 12A.

The second reflective film 22A is provided at the center of the movable section 121A. In the example illustrated in FIG. 5, the second reflective film 22A is formed in a circular shape, but this is not a limitation. For example, the second reflective film 22A may have a rectangular shape. In the case where the movable section 121A and the second reflective film 22A are formed in a rectangular shape, the area utilization efficiency can be improved as compared with the case where the second reflective film 22A having a circular shape is provided on the movable section 121A having a rectangular shape.

The second drive electrodes 32A are provided on the movable section 121A and are, for example, formed in a rectangular frame shape surrounding the second reflective film 22A. drive second drive electrode It should be noted that in the example illustrated in FIG. 5, the figure is simplified and only one of the second drive electrodes 32A is disposed, but as in the first embodiment, the bias second drive electrodes 321 and the control second drive electrodes 322 may be provided. In this case, for example, in the movable section 121A, one of the bias second drive electrodes 321 and the control second drive electrodes 322 is disposed on the side closer to the second reflective film 22A, and the other is disposed on the side farther from the second reflective film 22A.

In the example of FIG. 5, an example in which the second drive electrodes 32A are disposed in the movable section 121A is illustrated, but, similarly to the first embodiment, the second drive electrodes 32A may be provided from the movable section 121A to the displacement section 122A or may be provided in the displacement section 122A.

The second capacitance detection electrodes 42A are, as in the first embodiment, disposed on the displacement section 122A.

In the present embodiment illustrated in FIG. 5, the second capacitance detection electrodes 42A are disposed in the central portion of the displacement section 122A of the flexible section 122A3.

It should be noted that the arrangement positions of the second capacitance detection electrodes 42A are not limited to the positions illustrated in FIG. 5.

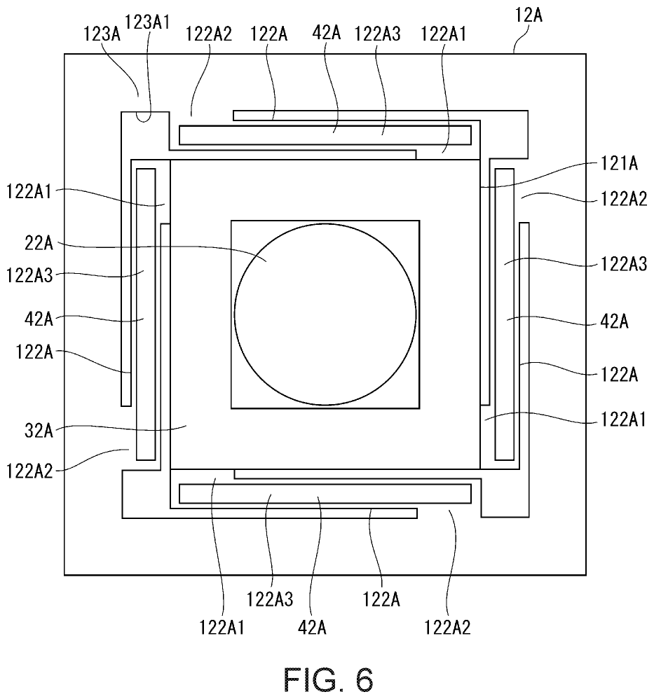

FIGS. 6 to 8 are plan views of the second substrate 12A illustrating other arrangement examples of the second capacitance detection electrodes 42A.

For example, as illustrated in FIG. 6, in the flexible 122A3 of the displacement section 122A, the second section capacitance detection electrodes 42A may be disposed from the first connection section 122A1 to the second connection section 122A2. In the case of FIG. 5 or FIG. 6, the coefficient a in the equation (1) is approximately equal to 5.

The second capacitance detection electrodes 42A can be set as appropriate based on the driving wavelength region of the variable wavelength interference filter and the dynamic range of the capacitance detection circuit 53.

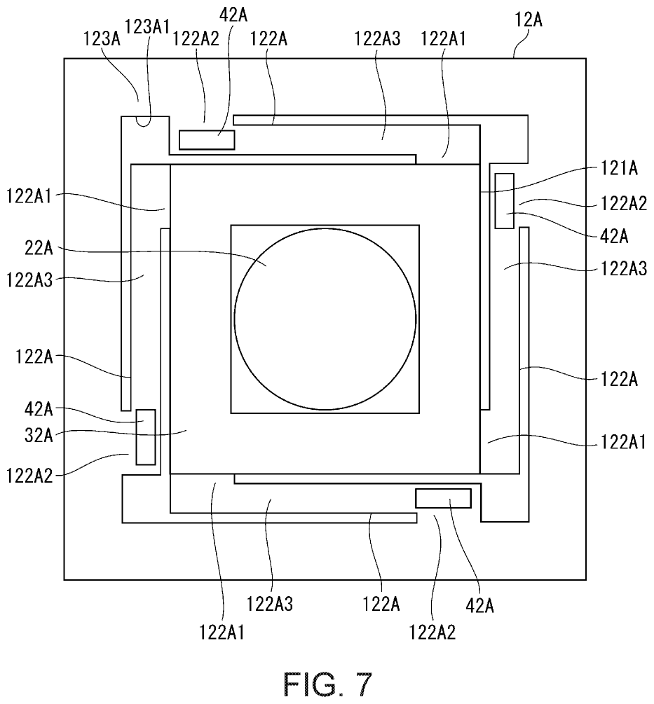

For example, in a case where the driving wavelength region of the variable wavelength interference filter is wide and the displaceable amount of the movable section 121A is large, when the second capacitance detection electrodes 42A are disposed on the first connection section 122A1 side, the electrostatic capacitance of the capacitance detection section 40 may change beyond the dynamic range of the capacitance detection circuit 53. In this case, as illustrated in FIG. 7, the second capacitance detection electrodes 42A are disposed on the second connection section 122A2 side, and the coefficient a in equation (1) is set to a value closer to 0. By this, even for the variable wavelength interference filter having a wide driving wavelength region, it is possible to appropriately calculate the distance of the inter-reflecting film gap G1.

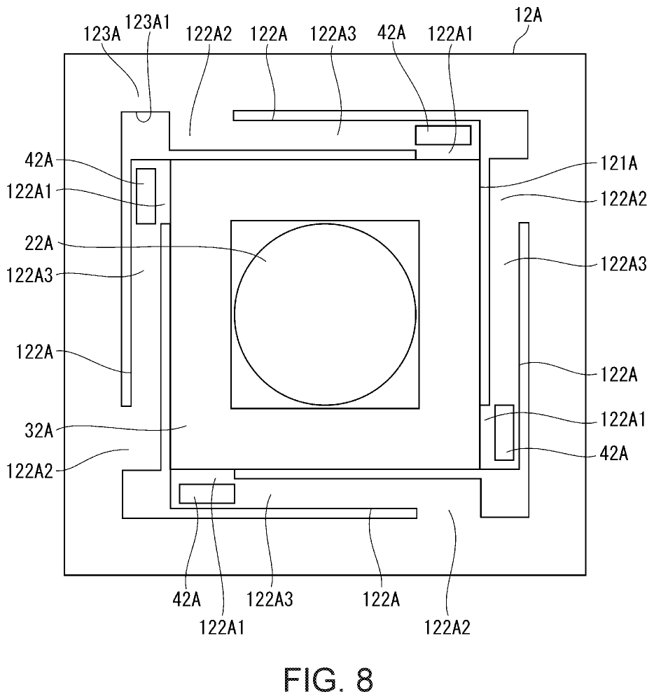

On the other hand, in a case where the driving wavelength region of the variable wavelength interference filter is narrow, when the second capacitance detection electrodes 42A are disposed on the second connection section 122A2 side, it is difficult for the capacitance detection circuit 53 to detect a change in the electrostatic capacitance in the capacitance detection section 40. In such a case, as illustrated in FIG. 8, the second capacitance detection electrodes 42A are disposed on the first connection section 122A1 side, and the coefficient a in equation (1) is set to a value closer to 1. By this, even in a variable wavelength interference filter having a narrow driving wavelength region, it is possible to detect the change in the distance of the inter-reflecting film gap G1 with high accuracy.

The first substrate of the second embodiment has the same configuration as that of the first embodiment, but the first reflective film 21, the first drive electrodes 31, and the first capacitance detection electrodes 41 are formed in the same shapes as the second reflective film 22A, the second drive electrodes 32A, and the second capacitance detection electrodes 42A, respectively, and, as described above, are disposed to face the second reflective film 22A, the second drive electrodes 32A, and the second capacitance detection electrodes 42A.

The variable wavelength interference filter according to the present embodiment described above can exhibit the same operational effects as those of the first embodiment.

In addition, in the present embodiment, the displacement section 122A is configured by the beams that bridge the movable section 121A and the support 123A.

In such a configuration, when the driving wavelength region is wide (the displacement amount x of the movable section 121A is large), the displacement section 122A can be deformed suitably. Further, even when the deformation of the displacement section 122A is large, by setting the appropriate coefficient a according to the arrangement position of the second capacitance detection electrodes 42A, the displacement amount x of the movable section 121A can be calculated with high accuracy.

### Third Embodiment

Next, a third embodiment will be described.

In the first embodiment, a configuration is exemplified in which the second reflective film 22 is provided on the second substrate 12, but a configuration in which the second reflective film is provided instead of the second substrate 12 may be adopted.

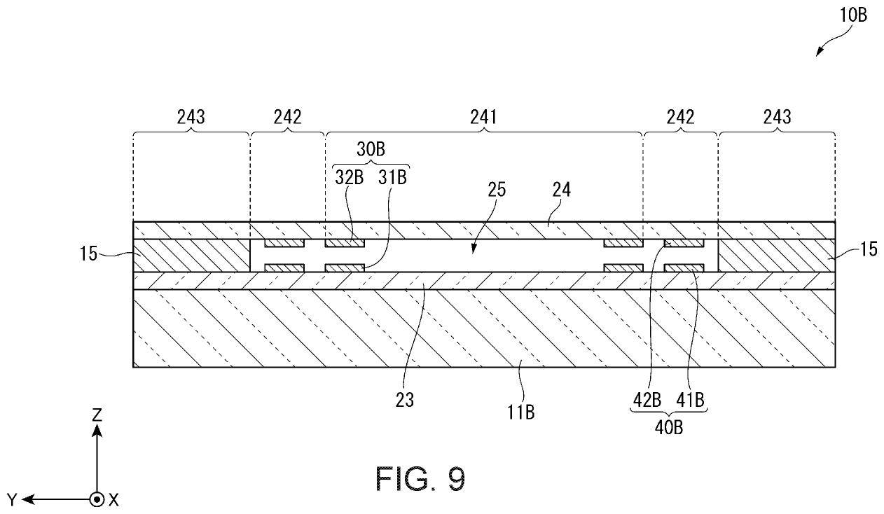

FIG. 9 is a cross-sectional view illustrating a schematic configuration of a variable wavelength interference filter according to the third embodiment.

In a variable wavelength interference filter 10B of the present embodiment, the second substrate 12 is not provided, and instead, the second reflective film 24 is disposed to face a first substrate 11B via a spacer 15. That is, in the present embodiment, the second reflective film 24 functions as a second substrate of the present disclosure.

In the present embodiment, the surface of the first substrate 11B facing the second reflective film 24 is the flat surface on the +Z side, and the first reflective film 23 is disposed on the entire surface on the +Z side of the first substrate 11B. In the first reflective film 23, first drive electrodes 31B are disposed at a position facing second drive electrodes 32B (to be described later), and first capacitance detection electrodes 41B is disposed at positions facing second capacitance detection electrodes 42B (to be described later). In the example illustrated in FIG. 9, the first reflective film 23 is disposed on the entire surface of the +Z side of the first substrate 11B, but a configuration may be adopted in which, using the first substrate 11 similar to that of the first embodiment, the first reflective film 21 is provided on the reflection film installation section 111.

Here, the central portion of the variable wavelength interference filter 10B is a multiple reflection region 25 in which the incident light is multiply reflected by the first reflective film 23 and the second reflective film 24.

In the variable wavelength interference filter 10B, the electrostatic actuators 30B are disposed so as to surround the periphery of the multiple reflection region 25. That is, in the first substrate 11B, the first drive electrodes 31B are disposed on the +Z side surface of the first reflective film 23 so as to surround the multiple reflection region 25. In the second reflective film 24, the second drive electrodes 32B are disposed on the −Z side surface of the second reflective film 24 so as to surround the multiple reflection region 25. When a drive voltage is applied to the electrostatic actuators 30B, the second drive electrodes 32B of the second reflective film 24 and the second reflective film 24 in the multiple reflection region 25, which is surrounded by the second drive electrodes 32B, are displaced toward the first substrate 11. That is, in the present embodiment, the region of the second reflective film 24, which functions as the second substrate, that overlaps the second drive electrodes 32B and the multiple reflection region 25 in the Z-direction functions as the movable section 241.

The region of the second reflective film 24 that overlaps the spacer 15 in the Z-direction on the outer side (the side separated from the multiple reflection region 25) of the second drive electrodes 32B functions as a support 243. A region of the second reflective film 24 between the movable section 241 and the support 243 functions as a displacement section 242 and is a region that bends when the movable section 241 is displaced in the Z-direction.

In the present embodiment, the second capacitance detection electrodes 42B constituting the capacitance detection section 40B are disposed in the displacement section 242.

The arrangement position of the second capacitance detection electrodes 42B with respect to the displacement section 242 is the same as in the first embodiment and the second embodiment, and can be appropriately set according to the driving wavelength region of the variable wavelength interference filter 10B, and by this, the value of the corresponding coefficient a is determined.

The variable wavelength interference filter 10B according to the third embodiment described above can also provide the same operational effects as those of the first embodiment described above.

Since the second substrate 12 is not required, the number of components can be reduced, and the variable wavelength interference filter 10B can be simplified.

### MODIFICATIONS

It should be noted that the present disclosure is not limited to the above-described embodiments, and modifications, improvements, and the like that can achieved the present disclosure are included herein.

### First Modification

In the first embodiment, the configuration in which the bias drive electrodes 311, 321 and the control drive electrodes 312, 322 are provided as the electrode patterns of the first drive electrodes 31 and the second drive electrodes 32 is illustrated, but this configuration is not a limitation.

For example, only one first drive electrode 31 may be provided, and correspondingly, only one second drive electrode 32 may be provided.

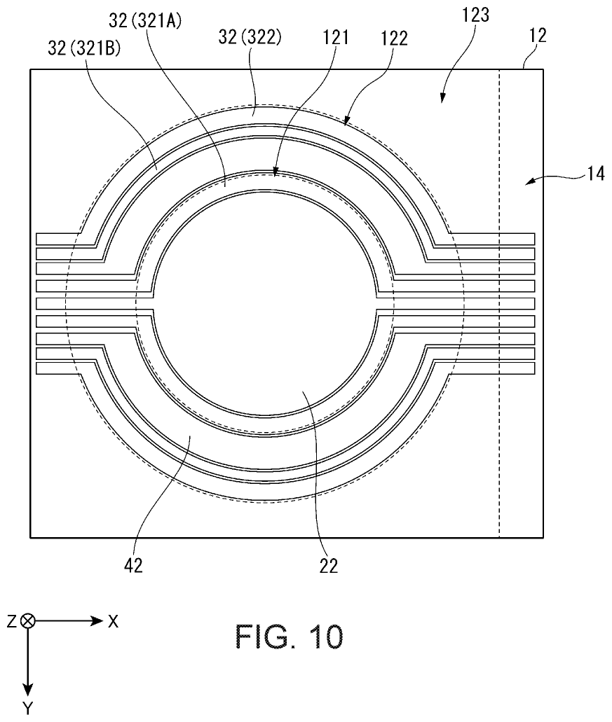

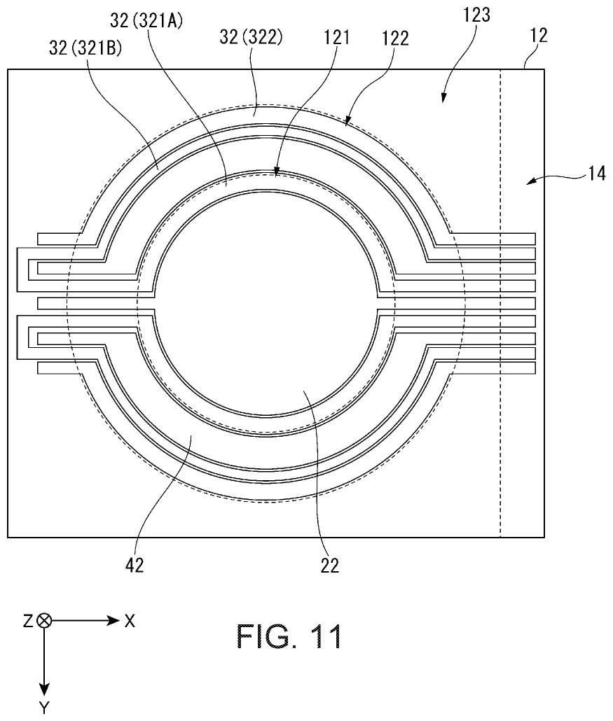

The first drive electrodes 31 and the second drive electrodes 32 may be configured by more electrodes. FIGS. 10 and 11 are diagrams illustrating an example of an electrode pattern provided on the second substrate 12 according to the first modification.

For example, as illustrated in FIG. 10, the bias inner second drive electrodes 321A may be provided on the outer side of the second reflective film 22, the second capacitance detection electrodes 42 may be provided on the outer side of the bias inner second drive electrodes 321A, the bias outer second drive electrodes 321B may be provided on the outer side of the second capacitance detection electrodes 42, and the control second drive electrodes 322 may be provided on the outer side of the bias outer second drive electrodes 321B.

In the example of FIG. 10, the bias inner second drive electrodes 321A and the bias outer second drive electrodes 321B are different electrodes, but may be the same electrodes.

For example, FIG. 11 illustrates a configuration example in which the bias inner second drive electrodes 321A and the bias outer second drive electrodes 321B are connected by wire connection in the support 123.

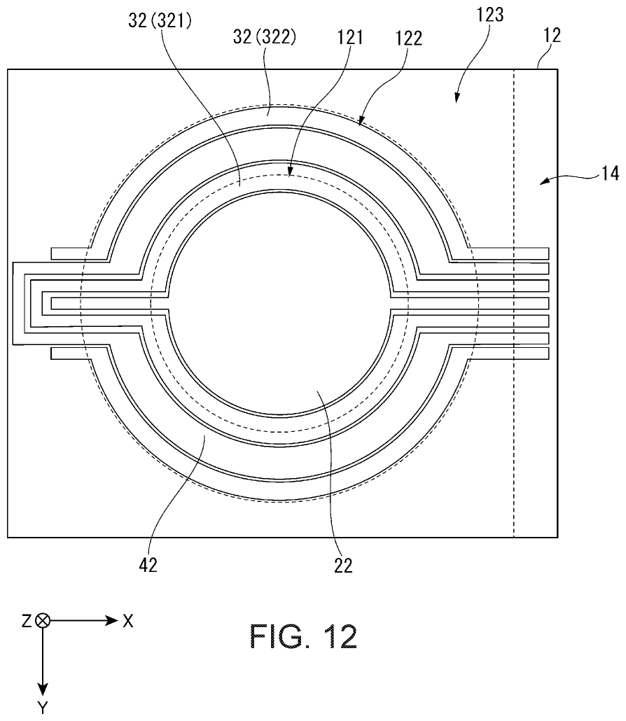

Further, as illustrated in FIG. 12, in the first embodiment, a pair of bias second drive electrodes 321, which are symmetric with respect to the reference line L1, may be connected. In this case, the bias drive electrodes 311, 321 are not divided and are controlled by one bias control circuit 51. The same applies to the second capacitance detection electrodes 42, and in a case where the electrostatic capacitance is measured using one capacitance detection circuit 53, a pair of second capacitance detection electrodes 42 may be connected by an electrode pattern or the like.

### Second Modification

In the first embodiment, as described above, the pair of drive electrodes 31, 32 and the pair of capacitance detection electrodes 41, 42, which are symmetric with respect to the reference line L1, may be independently driven. In this case, only the inclination along the Y-direction is detected, but by dividing the drive electrodes 31, 32 and the capacitance detection electrodes 41 and 42 into three or more, the inclination of the movable section 121 in the X-direction and the Y-direction can be detected.

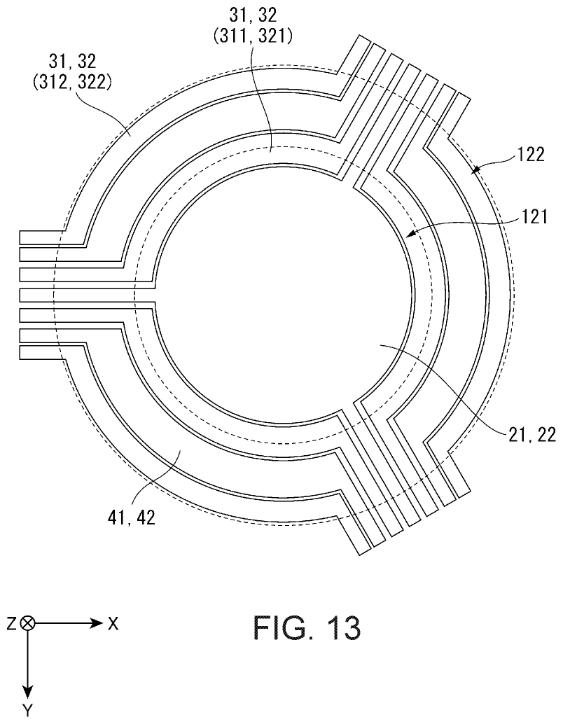

FIG. 13 is a diagram illustrating an electrode configuration example of the variable wavelength interference filter according to a second modification.

For example, FIG. 13 illustrates an example in which the drive electrodes 31, 32 and the capacitance detection electrodes 41 and 42 are divided into three. In this case, it is preferable that the filter control section 50 includes three bias control circuits 51 and three feedback control circuits 52 corresponding to the respective drive electrodes 31, 32 so that the drive electrodes 31, 32 (the bias drive electrodes 311, 321 and the control drive electrodes 312, 322) divided into three can be independently driven. Similarly, it is preferable that the filter control section 50 includes three capacitance detection circuits 53 corresponding to the respective capacitance detection electrodes 41, 42 so that the electrostatic capacitance of each of the three divided capacitance detection electrodes 41, 42 can be measured.

It is preferable that the filter control section 50 includes three bias control circuits 51 and three feedback control circuits 52 corresponding to the respective drive electrodes 31, 32 so that the drive electrodes 31, 32 (the bias drive electrodes 311, 321 and the control drive electrodes 312, 322) divided into three can be independently driven.

### Third Modification

In the embodiment, the configuration is exemplified in which the electrostatic actuators 30 constituting the electrostatic actuator include the bias drive electrodes 311, 321 and the control drive electrodes 312, 322, but the electrostatic actuators 30 may be constituted by a single first drive electrode provided on the first substrate 11 and a single second drive electrode provided on the second substrate 12. In this case, the bias control circuit 51 is not necessary in the filter control section 50. The filter control section 50 applies, from the feedback control circuit 52, a drive voltage corresponding to the target wavelength to the electrostatic actuators 30 and the filter control section 50 finely adjusts the drive voltage based on the electrostatic capacitance detected by the capacitance detection section 40.

### Fourth Modification

In the above embodiment, after the capacitance of the capacitance detection section 40 is measured by the capacitance detection circuit 53, the measurement result is output to the microcomputer 55, and the microcomputer 55 calculates the displacement amount x of the movable section 121 and outputs the control voltage command including the control voltage corresponding to the displacement amount x to the feedback control circuit 52. In contrast, the capacitance detection circuit 53 may calculate the displacement X amount of the movable section 121 from the measurement result of the electrostatic capacitance. In this case, without passing through the microcomputer 55, the displacement amount x may be directly output from the capacitance detection circuit 53 to the feedback control circuit 52. By this, the feedback control circuit 52 can apply a control voltage based on the target wavelength (or the target distance) input from the microcomputer 55 and the displacement amount x of the movable section 121 input from the capacitance detection circuit 53 to the control drive electrodes 312, 322.

### Fifth Modification

In the above embodiment, an example in which the second capacitance detection electrodes 42 are provided in the displacement section 122 is shown, but a configuration in which the second capacitance detection electrodes 42 are provided from the movable section 121 to the displacement section 122 may be adopted.

### SUMMARY OF THE PRESENT DISCLOSURE

Variable wavelength interference filter according to the first aspect in the present disclosure includes a first substrate;
a second substrate that is a substrate disposed to face the first substrate in a first direction and that includes a movable section facing the first substrate via a gap, a support bonded to the first substrate, and a displacement section that connects the support and the movable section and that supports the movable section to be movable along the first direction; a first reflective film provided on the first substrate and forming a multiple reflection region that performs multiple reflection of incident light between the first reflective film and the movable section; a first capacitance detection electrode provided on the first substrate; a second capacitance detection electrode provided on the second substrate and facing the first capacitance detection electrode in the first direction; and a electrostatic actuator that changes a reflection region distance that is a distance in the first direction in the multiple reflection region, wherein the second capacitance detection electrode is provided at least in the displacement section.

In the present aspect, by providing the second capacitance detection electrode in the displacement section, it is possible to increase the design flexibility in designing the second capacitance detection electrode.

The variable wavelength interference filter in the present aspect is desirably such that
assuming that a capacitance between the first capacitance detection electrode and the second capacitance detection electrode is C, a dielectric constant of a medium between the first capacitance detection electrode and the second capacitance detection electrode is ε, an electrode area where the first capacitance detection electrode and the second capacitance detection electrode overlap when viewed from the first direction is S, an initial value of the reflection region distance when the reflection region distance is not changed by the electrostatic actuator is Gmᵢₙᵢ, an offset amount between an average value of the capacitance detection inter-electrode gap between the first capacitance detection electrode and the second capacitance detection electrode when the reflection region distance is not changed by the electrostatic actuator and an initial value Gᵢₙᵢ of the reflection region distance is Gs_{off}, a change amount of the reflection region n distance by the electrostatic actuator is x, and a predetermined coefficient that is greater than 0 and less than 1 is a, then equation (1) is satisfied.

$$Equation 2$$

$$C = \frac{ε S}{( {Gm}_{ini} - {Gs}_{off} ) - x \cdot α} \qquad ( 1 )$$

In the present aspect, since the variable wavelength interference filter satisfies equation (1), the displacement amount x of the movable section can be calculated with high accuracy by measuring the electrostatic capacitance between the first capacitance detection electrode and the second capacitance detection electrode.

The variable wavelength interference filter in the present aspect is desirably such that the displacement section is a diaphragm surrounding an outer periphery of the movable section.

In the present aspect, since the displacement section is a diaphragm surrounding the movable section, as compared with a case where a through hole along the first direction is provided between the movable section and the support of the second substrate, the stiffness of the second substrate can be ensured.

The variable wavelength interference filter in the present aspect may be such that the displacement section is a beam member that bridges the movable section and the support.

In the present aspect, since the displacement section is the beam member, it is possible to widen the movable region of the movable section, that is, the driving wavelength region of the variable wavelength interference filter.

The variable wavelength interference filter in the present aspect is desirably such that the electrostatic actuator includes a first drive electrode provided on the first substrate and a second drive electrode that is provided on the second substrate and that faces the first drive electrode, the second drive electrode and the second capacitance detection electrode are provided on the displacement section, and in the displacement section, the second capacitance detection electrode is disposed at a side closer to the support than the second drive electrode.

In the present aspect, the displacement amount of the movable section can be calculated with high accuracy.

What is claimed is:

1. A variable wavelength interference filter comprising:
a first substrate;
a second substrate that is a substrate disposed to face the first substrate in a first direction and that includes a movable section facing the first substrate via a gap, a support bonded to the first substrate, and a displacement section that connects the support and the movable section and that supports the movable section to be movable along the first direction;
a first reflective film provided on the first substrate and forming a multiple reflection region that performs multiple reflection of incident light between the first reflective film and the movable section;
a first capacitance detection electrode provided on the first substrate;
a second capacitance detection electrode provided on the second substrate and facing the first capacitance detection electrode in the first direction; and
an electrostatic that changes a reflection region distance that is a distance in the first direction in the multiple reflection region, wherein
the second capacitance detection electrode is provided at least in the displacement section.

2. The variable wavelength interference filter according to claim 1, wherein
assuming that a capacitance between the first capacitance detection electrode and the second capacitance detection electrode is C, a dielectric constant of a medium between the first capacitance detection electrode and the second capacitance detection electrode is ε, an electrode area where the first capacitance detection electrode and the second capacitance detection electrode overlap when viewed from the first direction is S, an initial value of the reflection region distance when the reflection region distance is not changed by the electrostatic actuator is Gmᵢₙᵢ, an offset amount between an average value of the capacitance detection inter-electrode gap between the first capacitance detection electrode and the second capacitance detection electrode when the reflection region distance is not changed by the electrostatic actuator and an initial value Gᵢₙᵢ of the reflection region distance is Gs_{off}, a change amount of the reflection region distance by the electrostatic actuator is x, and a predetermined coefficient that is greater than 0 and less than 1 is a, then Equation 1
$$C = \frac{ε S}{( {Gm}_{ini} - {Gs}_{off} ) - x \cdot α} \qquad ( 1 )$$
is satisfied.

3. The variable wavelength interference filter according to claim 1, wherein
the displacement section is a diaphragm surrounding an outer periphery of the movable section.

4. The variable wavelength interference filter according to claim 1, wherein
the displacement section is a beam member that bridges the movable section and the support.

5. The variable wavelength interference filter according to claim 3, wherein
the electrostatic actuator includes a first drive electrode provided on the first substrate and a second drive electrode that is provided on the second substrate and that faces the first drive electrode,
the second drive electrode and the second capacitance detection electrode are provided on the displacement section, and in the displacement section, the second capacitance detection electrode is disposed at a side closer to the support than the second drive electrode.
